(19) United States
(12) Patent Application Publication
(10) Pub. No.: US 2022/0230119 A1
(43) Pub. Date: Jul. 21, 2022

(54) COMPUTER AND MEASURE EVALUATING METHOD

(71) Applicant: Hitachi, Ltd., Tokyo (JP)

(72) Inventors: Yuxin LIANG, Tokyo (JP); Masashi EGI, Tokyo (JP); Yusuke FUNAYA, Tokyo (JP); Masakazu TAKAHASHI, Tokyo (JP)

(21) Appl. No.: 17/468,797

(22) Filed: Sep. 8, 2021

(30) Foreign Application Priority Data
Jan. 19, 2021 (JP) 2021-006455

(51) Int. Cl. G06Q 10/06; G06F 3/0482

(52) U.S. Cl. CPC G06Q 10/06395; G06F 3/0482; G06Q 10/06375

(57) ABSTRACT

A computer has: a testing unit obtaining attribute values of attributes from an object to which a measure is implemented and an object to which the measure is not implemented, and calculating a change amount of the attribute values of the attributes due to the implementation of the measure and a test indicator for determining a significant difference of the change amount of the attribute values of the attributes due to the implementation of the measure; an experimental rule updating unit calculating a cumulative change amount indicating a temporal change amount of the attribute values of the attributes and a cumulative test indicator indicating a temporal test indicator of the attributes on the basis of a test result output from the testing unit, and accumulating data in which the identification information of the measure and the cumulative change amount and the cumulative test indicator are associated; and a display unit.

### CLAIM OF PRIORITY

The present application claims priority from Japanese patent application JP 2021-006455 filed on Jan. 19, 2021, the content of which is hereby incorporated by reference into this application.

### BACKGROUND

The present invention relates to a technique of evaluating a measure implemented for an object.

To improve indicators such as operational efficiency, productivity, and sales, various measures are implemented. As a method of evaluating a measure, for example, the technique described in International Publication WO 2017/72869 (patent literature 1) is known.

International Publication WO 2017/72869 discloses “a measure evaluation system for the purpose of further suppressing reduction of a process amount at the time of evaluating the effect of a measure by using KPI, which includes: a fundamental indicator calculating unit that groups data to a measure target and a non-measure target and calculates a fundamental indicator of the measure target before implementation of the measure and a fundamental indicator of the non-measure target before implementation of the measure; a fundamental indicator designating unit that generates an estimation model indicating the relation between the fundamental indicator of the measure target and the fundamental indicator of the non-measure target every fundamental indicator and, on the basis of the fundamental indicator of the measure target after implementation of the measure and the estimation model, estimates an estimation fundamental indicator as a fundamental indicator in the case where the measure is not implemented for the measure target; and a KPI evaluation calculating unit that receives a KPI definition constructed by arithmetic operation of a plurality of fundamental indicators and calculates an estimation KPI value corresponding to the KPI definition by using the KPI definition and the estimation fundamental indicator”.

A method of evaluating a measure by performing an A/B test is also known. In an A/B test, a significant difference is tested with respect to an indicator such as KPI between a group A and a group B.

### SUMMARY

Even a measure whose effect is recognized, the effect of the measure exerted on an indicator varies according to a change of the environment which exerts an influence on measure implementation timing and an object as a target to which a measure is implemented.

Conventionally, a measure implemented is verified but time change of the effect of a measure is not considered. The present invention provides a technique of presenting evaluation information of a measure in which time change is reflected.

A representative example of the invention disclosed in the present application will be described as follows. A computer including a processor and a storage device connected to the processor has: a testing unit obtaining attribute values of a plurality of attributes from an object to which a measure is implemented and an object to which the measure is not implemented, calculating a change amount of the attribute values of the plurality of attributes by the implementation of the measure, and calculating a test indicator for determining a significant difference of the change amount of the attribute values of the plurality of attributes by the implementation of the measure; an experimental rule updating unit accumulating a test result output from the testing unit, on the basis of the test result, calculating a cumulative change amount indicating a temporal change amount of the attribute values of the plurality of attributes by the implementation of the measure and a cumulative test indicator indicating a temporal test indicator of the plurality of attributes by the implementation of the measure, and accumulating data in which the identification information of the measure and the cumulative change amount and the cumulative test indicator of the plurality of attributes are associated; and a display unit displaying the cumulative change amount and the cumulative test indicator associated with a designated measure on the basis of the data.

According to the present invention, a computer can present evaluation information of a measure in which time change is reflected. The other objects, configurations, and effects will become apparent from the description of the following embodiments.

### BRIEF DESCRIPTION OF THE DRAWINGS

FIG. 1 is a diagram illustrating an example of a functional configuration of a computer of a first embodiment.

FIG. 2 is a diagram illustrating an example of a hardware configuration of the computer of the first embodiment.

FIG. 3 is a diagram illustrating an example of measure management information of the first embodiment.

FIG. 4A is a diagram illustrating an example of object management information of the first embodiment.

FIG. 4B is a diagram illustrating an example of the object management information of the first embodiment.

FIG. 5 is a diagram illustrating an example of performance management information of the first embodiment.

FIG. 6 is a diagram illustrating an example of test record of the first embodiment.

FIG. 7 is a flowchart explaining an example of processes executed by a planning unit of the first embodiment.

FIG. 8 is a flowchart explaining an example of processes executed by a testing unit of the first embodiment.

FIG. 9 is a flowchart explaining an example of processes executed by an experimental rule updating unit of the first embodiment.

FIG. 10 is a diagram illustrating an example of a screen displayed by the display unit of the first embodiment.

FIG. 11 is a diagram illustrating an example of a functional configuration of a computer of a second embodiment.

FIG. 12 is a diagram illustrating an example of experimental rule record of the second embodiment.

FIG. 13 is a flowchart explaining an example of processes executed by an experimental rule updating unit of the second embodiment.

FIG. 14 is a diagram illustrating an example of a screen displayed by a display unit of the second embodiment.

FIG. 15 is a diagram illustrating an example of a functional configuration of a computer of a third embodiment.

FIG. 16 is a diagram illustrating an example of periodicity analysis information of the third embodiment.

FIG. 17 is a flowchart explaining an example of processes executed by an experimental rule updating unit of the third embodiment.

FIG. 18 is a flowchart explaining an example of processes executed by an experimental rule updating unit of a fourth embodiment.

### DETAILED DESCRIPTION

Hereinafter, embodiments of the present invention will be described with reference to the drawings. However, the present invention is not interpreted by being limited to the description of the following embodiments. It is easily understood by a person skilled in the art that the concrete configuration of the present invention can be changed without departing from the idea and gist of the invention.

In the configurations of the invention described hereinafter, the same reference numeral is designated to the same or similar configuration or function and repetitive description will be omitted.

Expressions such as “first”, “second”, and “third” in the specification and the like are designated for discriminating the components and are not always limited to numbers or orders.

### First Embodiment

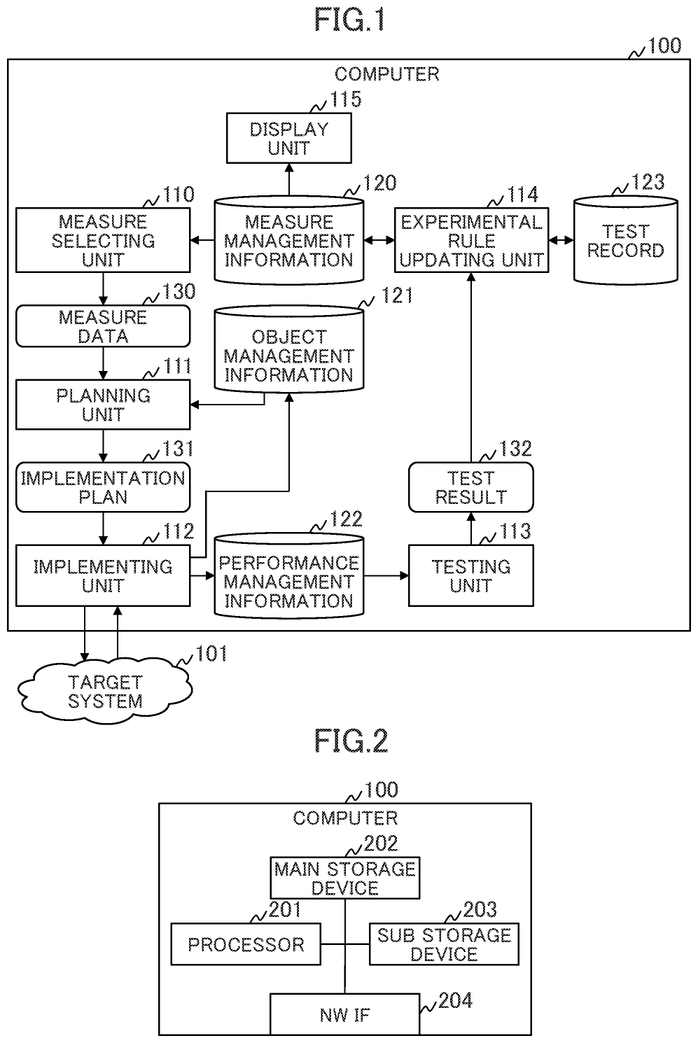

FIG. 1 is a diagram illustrating an example of a functional configuration of a computer 100 of a first embodiment. FIG. 2 is a diagram illustrating an example of a hardware configuration of the computer of the first embodiment.

The computer 100 performs selection of a measure, generation of a measure implementation plan, accumulation of performances of measures, and evaluation of a measure. The computer 100 is connected to a target system 101. The computer 100 and the target system 101 are connected via a network such as a LAN (Local Area Network) and a WAN (Wide Area Network).

The target system 101 is a system performing management, control, or monitoring of an object as a target to which a measure is implemented. For example, the target system 101 is a system of managing a convenience store. Objects of the system are, for example, a convenience store and customers. The present invention is not limited to the kind of the target system 101. The target system 101 obtains a value of an attribute (attribute value) which characterizes an object and transmits it to the computer 100.

The computer 100 has, for example, a hardware configuration as illustrated in FIG. 2 and has a processor 201, a main storage device 202, a sub storage device 203, and a network interface 204. The hardware components are connected to one another via a bus. The computer 100 may have input devices such as a keyboard, a mouse, and a touch panel and have output devices such as a display and a printer.

The processor 201 executes a program stored in the main storage device 202. By executing a process according to the program, the processor 201 operates as a function unit (module) realizing a specific function. In the following description, in the case of describing a process using the function unit as a subject, it indicates that the processor 201 executes the program realizing the function unit.

The main storage device 202 is a storage device such as a DRAM (Dynamic Random Access Memory) and stores a program executed by the processor 201 and data used by the program. The main storage device 202 is also used as a work area. The sub storage device 203 is a storage device such as an HDD (Hard Disk Drive) and an SSD (Solid State Drive) and stores data permanently.

A program and data stored in the main storage device 202 may be stored in the sub storage device 203. In this case, the processor 201 reads the program and data from the sub storage device 203 and loads them to the main storage device 202.

The main storage device 202 of the first embodiment stores a program realizing a measure selecting unit 110, a planning unit 111, an implementing unit 112, a testing unit 113, an experimental rule updating unit 114, and a display unit 115. The sub storage device 203 of the first embodiment stores measure management information 120, object management information 121, performance management information 122, and test record 123. The information stored in the sub storage device 203 may be stored in the main storage device 202.

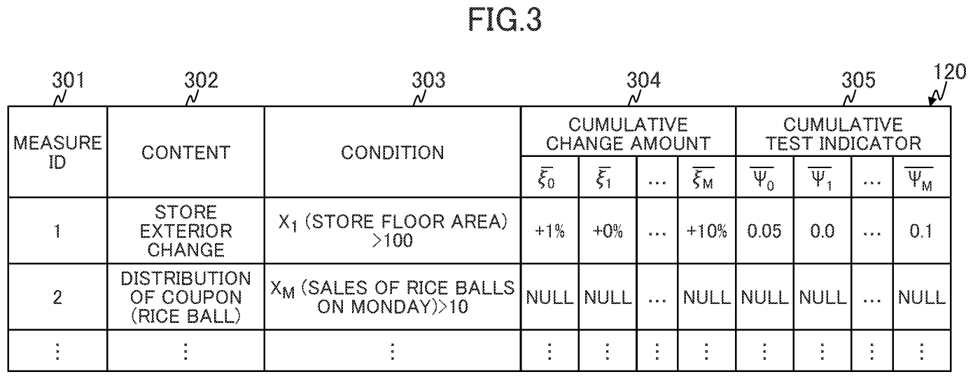

The measure management information 120 is information for managing a measure. As will be described later, a measure is managed in a state where a cumulative change amount and a cumulative test indicator of each attribute are associated. The cumulative change amount and the cumulative test indicator may be calculated by statistical process using an actual measurement value or the like or may be calculated by using prediction algorithm which is artificially determined. The details of the measure management information 120 will be described with reference to FIG. 3.

The cumulative change amount expresses a change amount of an attribute value (effect of a measure) which is chronological, and the cumulative test indicator expresses a chronological test indicator. The test indicator is an indicator for testing a significant difference of a change amount of an attribute value.

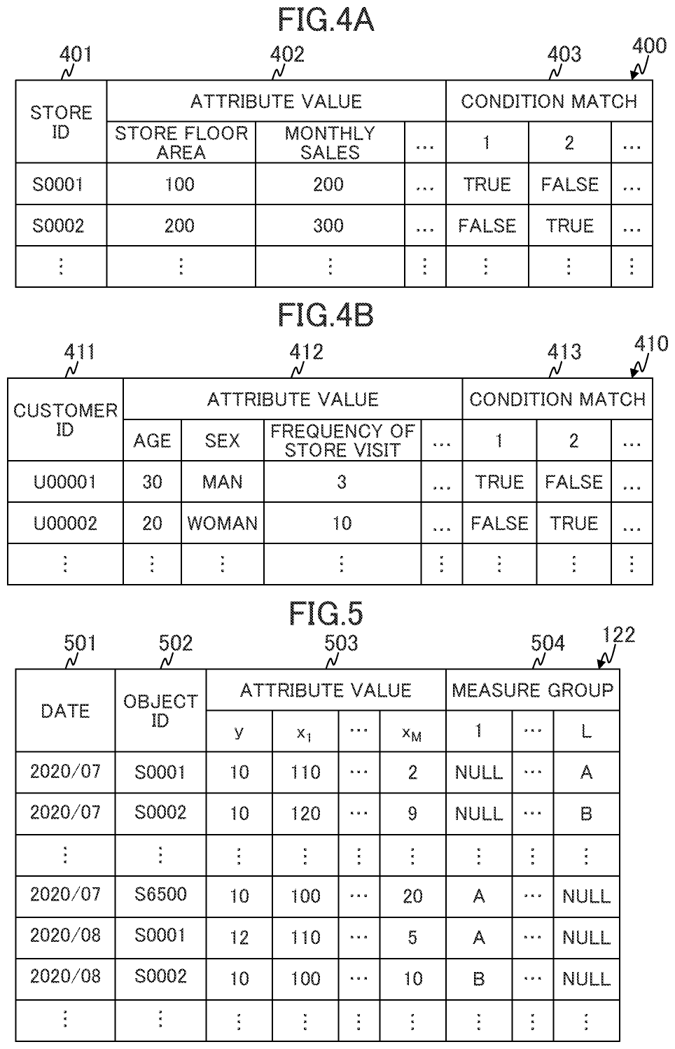

The object management information 121 is information for managing the latest attribute value of an attribute characterizing an object. The details of the object management information 121 will be described with reference to FIGS. 4A and 4B.

The performance management information 122 is information for managing an attribute value obtained from an object in accordance with implementation of a measure and an evaluation indicator calculated from the obtained attribute value. The details of the performance management information 122 will be described with reference to FIG. 5.

An evaluation indicator is a kind of an attribute and calculated from an evaluation model using an arbitrary attribute as a variable. The evaluation indicator is, for example, a KPI (Key Performance Indicator). The evaluation model is a mathematical model using an attribute as an explanatory variable. In the first embodiment, it is assumed that one evaluation model is set. An evaluation model may be set for each measure.

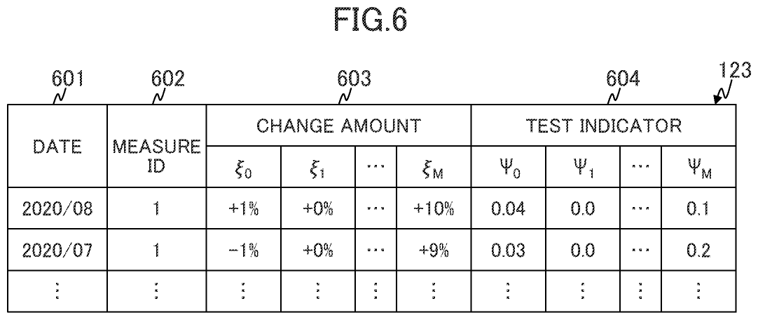

The test record 123 is information for managing a result of a significant difference test for a measure. The details of the test record 123 will be described with reference to FIG. 6.

The measure selecting unit 110 selects a measure to be implemented from measures managed by the measure management information 120 and outputs measure data 130 including the information regarding the measure.

The planning unit 111 generates an implementation plan 131 of a measure on the basis of the measure data 130 and the object management information 121 and outputs the implementation plan 131. To conduct an A/B test, the planning unit 111 selects a group A made of objects to which a measure is implemented and a group B made of objects to which a measure is not implemented.

The implementing unit 112 implements a measure to the target system 101 on the basis of the implementation plan 131 which is input. The implementing unit 112 may implement a measure directly to the object of the target system 101 and transmit an implementation request including identification information of the object and the content of the measure to the target system 101.

In the case where an attribute value of an object of each of the group A and the group B is obtained from the target system 101, the implementing unit 112 updates the object management information 121. Update of the object management information 121 is a concept including addition of a record, deletion of a record, and updating of a record. The implementing unit 112 calculates an evaluation indicator on the basis of an evaluation model and registers a record including an evaluation indicator and an attribute value of an attribute other than the evaluation indicator in the performance management information 122.

The testing unit 113 calculates a change amount of an attribute value of each attribute and a test indicator on the basis of the performance management information 122. A change amount of an attribute value and a test indicator are calculated on not only an attribute which is set as a target variable of an evaluation model but also an attribute which is set as an explanatory variable.

When a test result 132 is input, the experimental rule updating unit 114 registers the test result 132 in the test record 123 and updates a cumulative change amount and a cumulative test indicator.

The display unit 115 displays various information.

With respect to the function units of the computer 100, a plurality of function units may be combined as one function unit or one function unit may be divided into a plurality of function units by functions. For example, the testing unit 113 may include the implementing unit 112.

The function units of the computer 100 may be realized by using a computer system constructed by a plurality of computers. In this case, the function units may be disposed so as to be dispersed.

With reference to FIGS. 3 to 6, the details of information held by the computer 100 will be described.

FIG. 3 is a diagram illustrating an example of the measure management information 120 of the first embodiment.

As the measure management information 120, a record including a measure ID 301, a content 302, a condition 303, a cumulative change amount 304, and a cumulative test indicator 305 is stored. One record exists for one measure.

The measure ID 301 is a field for storing identification information for unconditionally identifying a measure. The content 302 is a field for storing the content of a measure. The condition 303 is a field for storing an application condition for selecting an object to which a measure is implemented.

The cumulative change amount 304 is a field group for storing cumulative change amounts of attributes. In the cumulative change amount 304, cumulative change amounts of attributes corresponding to explanatory variables and objective variables of an evaluation model are stored. The characters 0, 1, M, and the like are indexes for identifying attributes. In the embodiment, it is assumed that 0 expresses an objective variable, and 1 to M express explanatory variables.

In the cumulative change amount 304 of a record corresponding to a measure which has not been implemented even once, “null” is stored.

The cumulative test indicator 305 is a field group for storing cumulative test indicators of attributes. In the cumulative test indicator 305, cumulative test indicators of attributes corresponding to an explanatory variable and an objective variable of an evaluation model are stored. The characters 0, 1, M, and the like are indexes identifying attributes. In the embodiment, it is assumed that 0 expresses an objective variable and 1 to M express explanatory variables.

In the cumulative test indicator 305 of a record corresponding to a measure which has not been implemented even once, “null” is stored.

FIGS. 4A and 4B are diagrams illustrating an example of the object management information 121 of the first embodiment.

As the object management information 121, for example, as illustrated in FIGS. 4A and 4B, tables 400 and 410 are stored by kinds of objects.

The table 400 is a table managing a convenience store and stores a record including a store ID 401, an attribute value 402, and a condition match 403. One record exists for one convenience store.

The store ID 401 is a field for storing identification information which unconditionally identifies a convenience store.

The attribute value 402 is a field group for storing attribute values of attributes which characterize the convenience store. In the attribute value 402, attribute values of attributes such as store floor area and monthly sales are stored. The condition match 403 is a field group for storing determination values indicating whether a measure application condition is satisfied or not. The condition match 403 includes fields of the number equal to the number of measures. In the field, either “True” indicating that the measure application condition is satisfied or “False” indicating that the measure application condition is not satisfied is stored. As the initial value of each field, “False” is set.

The table 410 is a table for managing customers using a convenience store, and stores a record including a customer ID 411, an attribute value 412, and a condition match 413. One record exists for one customer.

The customer ID 411 is a field for storing identification information for unconditionally identifying a customer.

The attribute value 412 is a field group for storing attribute values of attributes that characterize the customer. In the attribute value 412, attribute values of attributes such as age, sex, and the frequency of visiting are stored. The condition match 413 is a field group for storing a determination value indicating whether a measure application condition is satisfied or not. The condition match 413 includes fields of the number equal to the number of measures. In each of the fields, either “True” or “False” is stored. As the initial value of each field, “False” is set.

FIG. 5 is a diagram illustrating an example of the performance management information 122 of the first embodiment.

The performance management information 122 stores a record including date 501, object ID 502, an attribute value 503, and a measure group 504. One record exists for a combination of date and an object.

The date 501 is a field for storing date of implementation of a measure. The object ID 502 is a field for storing identification information of an object.

The attribute value 503 is a field group for storing attribute values of attributes corresponding to an explanatory variable and an objective variable of an evaluation model. In FIG. 5, y indicates an objective variable of an evaluation model, and xᵢ expresses an explanatory variable. i indicates an index of the explanatory variable, which is an integer in the range of 1 to M.

The measure group 504 is a field group for storing a determination value indicating that a measure corresponds to the group A or B. The measure group 504 includes fields of the number equal to the number of measures. In each field, “A” indicating that the measure belongs to the group A, “B” indicating that the measure belongs to the group B, or “null” indicating that the measure does not belong to any group is stored.

FIG. 6 is a diagram illustrating an example of the test record 123 of the first embodiment.

The test record 123 stores a record including date 601, a measure ID 602, a change amount 603, and a test indicator 604. One record exists for a combination of date and a measure.

The date 601 is a field for storing measure implementation date. The measure ID 602 is a field for storing identification information of a measure.

The change amount 603 is a field group for storing a change amount of an attribute value of an attribute calculated by the testing unit 113. In the change amount 603, change amounts of attribute values of attributes corresponding to an explanatory variable and an objective variable of an evaluation model are stored.

The test indicator 604 is a field group for storing an attribute test indicator calculated by the testing unit 113. In the test indicator 604, test indicators of attributes corresponding to an explanatory variable and an objective variable of an evaluation model are stored.

Next, processes executed by the function units of the computer 100 will be described.

First, processes executed by the measure selecting unit 110 will be described.

When an implementation request or measure information is received from a user of the computer 100, the measure selecting unit 110 starts processing. It is assumed that the implementation request includes a measure implementation timing, and the measure information includes measure identification information and measure implementation timing.

When an implementation request is received, the measure selecting unit 10 selects the best measure at a ratio α and selects a measure at random at a ratio (1−α). The best measure is a measure by which the product of the change amount of the objective variable and the test indicator becomes the maximum. The measure selecting unit 110 outputs the measure data 130 including the values of the measure ID 301, the content 302, and the condition 303 of a record corresponding to the measure implementation timing and the selected measure.

When the measure information is received, the measure selecting unit 110 retrieves a record corresponding to a measure designated by the user by referring to the measure management information 120. The measure selecting unit 110 outputs the measure implementation timing and the measure data 130 including the values of the measure ID 301, the content 302, and the condition 303 of the retrieved record.

The process implemented by the planning unit 111 will be described.

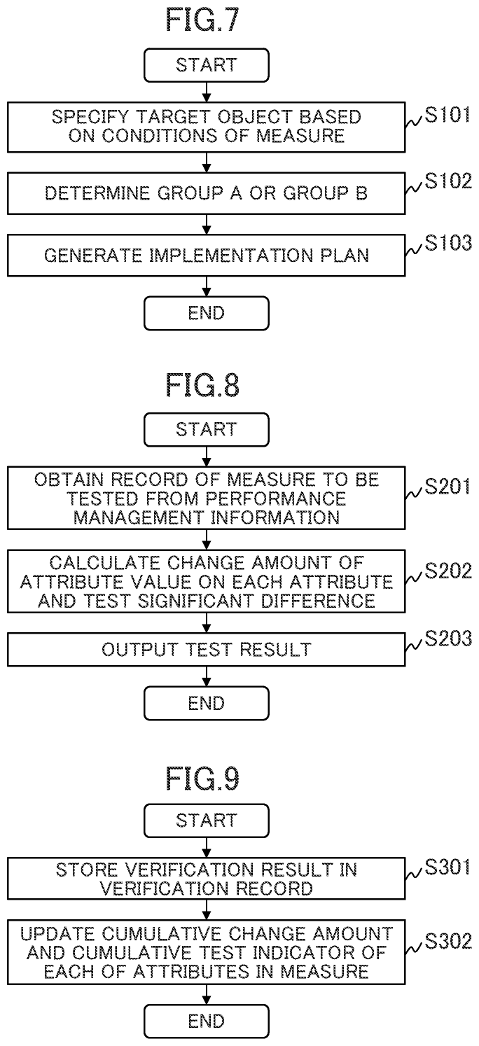

FIG. 7 is a flowchart explaining an example of processes executed by the planning unit 111 of the first embodiment.

When the measure data 130 is input from the measure selecting unit 110, the planning unit 111 starts processing.

The planning unit 111 refers to the object management information 121 on the basis of a condition of applying a measure included in the measure data 130 and specifies an object which matches the measure application condition (step S101).

At this time, the planning unit 111 adds information indicating that the condition matches the measure to a record of the object matching the measure application condition. For example, in the case of a system of managing convenience stores, either a convenience store or a customer is specified as an object. “True” is stored at least in either the field of the measure designated of the condition match 403 of the record in the table 400 or the field of the designated measure of the condition match 413 of the record in the table 410.

Next, the planning unit 111 classifies the specified object to the group A or the group B (step S102).

The planning unit 111 generates the implementation plan 131 made by measure implementation timing, content of the measure, an object belonging to the group A, and an object belonging to the group B, and outputs the implementation plan 131 to the implementing unit 112 (step S103).

Processes implemented by the implementing unit 112 will be described.

The implementing unit 112 implements the measure to the object in the group A on the basis of the implementation plan 131. In the case where an attribute value related to the object in the group A and an attribute value related to the object in the group B are obtained from the target system 101, the implementing unit 112 overwrites the attribute value on the record of the object management information 121 and determines whether the measure application condition is satisfied or not. The implementing unit 112 adds a record to the performance management information 122, stores the measure implementation date in the date 501 of the added record, stores identification information of the object in the object ID 502, and stores the attribute value of an attribute which is set as a variable of the evaluation model in the attribute value 503. The implementing unit 112 determines whether the object from which the attribute value is obtained belongs the group A or the group B on the basis of the implementation plan 131, and stores the determination result in the field of the measure implemented in the measure group 504 of the added record. “null” is stored in the fields of the other measures of the measure group 504.

The attribute value may be obtained by using a sensor mounted in the target system 101 or obtained on the basis of an input from the target system 101.

Processes executed by the testing unit 113 will be described.

FIG. 8 is a flowchart explaining an example of processes executed by the testing unit 113 of the first embodiment.

In the case where the performance management information 122 is updated or in the case where an implementation request is received from the user, the testing unit 113 starts processing. The implementation request includes measure identification information and measure implementation timing. Hereinafter, processes performed in the case where the implementation request is received from the user will be described.

The testing unit 113 obtains a record corresponding to a measure to be tested from the performance management information 122 (step S201).

Concretely, the testing unit 113 retrieves a record in which the implementation timing of a designated measure is stored in the date 501. The testing unit 113 refers to the measure group 504 of the retrieved record and obtains a record in which “A” or “B” is stored in the field of the designated measure.

The testing unit 113 calculates a change amount of an attribute value of each of attributes by using the obtained record and tests a significant difference of the change amount of the attribute value (step S202). Concretely, processes as described hereinafter are executed.

### (S202-1)

The testing unit 113 selects one attribute from attributes set as variables of the evaluation model.

### (S202-2)

The testing unit 113 calculates a change amount of the attribute value of the attribute selected by implementation of a measure by using the obtained record. For example, in the case where the measure implementation date is t+1 and date for verifying the effect of the measure is set as t, the testing unit 113 calculates a change amount of an attribute value xᵢ of an attribute i by using Formula (1).

### Change Amount:

$${ξ}_{i}^{t + 1} = {δ}_{i}^{A} - {δ}_{i}^{B} \qquad ( 1 )$$

δᵢ^{A} expresses a change amount of the attribute value xᵢ of the attribute i in the group A and is given by Formula (2). δᵢ^{B} expresses a change amount of the attribute value xᵢ of the attribute i in the group B and is given by Formula (3). The absolute value of G_{A} expresses the number of objects in the group A, and the absolute value of GB expresses the number of objects in the group B.

$${δ}_{i}^{A} = \frac{1}{\vert {G}_{A} \vert} {\sum }_{j ∈ {G}_{A}} ( {x}_{j , i}^{t + 1} - {x}_{j , i}^{t} ) \qquad ( 2 )$$

$${δ}_{i}^{B} = \frac{1}{\vert {G}_{B} \vert} {\sum }_{j ∈ {G}_{B}} ( {x}_{j , i}^{t + 1} - {x}_{j , i}^{t} ) \qquad ( 3 )$$

i denotes an integer in the range of 0 to M, the attribute i which is 0 corresponds to the objective variable of the evaluation model, and the attribute i which is other than 0 corresponds to an explanatory variable of the evaluation model.

### (S202-3)

Using the obtained record, the testing unit 113 calculates a test indicator expressing certainty of a change of the attribute value of the attribute selected by the implementation of the measure. For example, when the measure implementation date is t+1, the testing unit 113 calculates the p value of the change amount of the attribute value xᵢ of the attribute i as illustrated in Formula (4) as the test indicator.

### Test Indicator:

$${Ψ}_{i}^{t + 1} = p ( {ξ}_{i}^{t + 1} ) \qquad ( 4 )$$

### (S202-4)

The testing unit 113 stores intermediate data including an attribute, a change amount, and a test indicator in the work area.

### (S202-5)

The testing unit 113 determines whether or not the process has been completed on all of the attributes set as the variables of the evaluation model. When the process has not been completed on all of the attributes, the testing unit 113 returns to S202-1.

### (S202-5)

When the process is completed on all of the attributes, the testing unit 113 finishes the process of step S202.

In the first embodiment, by testing a significant difference on all of attributes, the influence of a measure to each of the attributes of an object can be evaluated exhaustively.

The process in step S202 has been described above.

The testing unit 113 generates the test result 132 including identification information and implementation date of a designated measure and intermediate data of each of attributes and outputs the test result 132 to the experimental rule updating unit 114 (step S203).

Processes executed by the experimental rule updating unit 114 will be described.

FIG. 9 is a flowchart explaining an example of processes executed by the experimental rule updating unit 114 of the first embodiment.

When the test result 132 is input from the testing unit 113, the experimental rule updating unit 114 starts processing.

The experimental rule updating unit 114 stores the test result 132 in the test record 123 (step S301).

Concretely, the experimental rule updating unit 114 adds a record to the test record 123 and, on the basis of the test result 132, stores values in the fields of the added record.

The experimental rule updating unit 114 updates a cumulative change amount and a cumulative test indicator of each of the attributes in the measure to be tested (step S302). Examples of the method of updating the cumulative change amount and the cumulative test indicator are as follows.

### Updating Method 1

The experimental rule updating unit 114 updates the cumulative change amount of each attribute by calculating cumulative addition mean of the cumulative change amount by using a decreasing rate (1−γ) as indicated by Formula (5). The experimental rule updating unit 114 updates the cumulative test indicator by calculating cumulative addition mean of the cumulative test indicator by using the decreasing rate (1−γ) as indicated by Formula (6). δᵢ^{t} with a bar expresses a cumulative change amount before the attribute i is updated, and ψᵢ^{t} with a bar expresses a cumulative test indicator before the attribute i is updated. The decreasing rate is a value which is larger than 0 and smaller than 1.

$$\overline{{ξ}_{ι}^{t + 1}} = ( 1 - γ ) \overline{{ξ}_{ι}^{t}} + {γξ}_{i}^{t + 1} \qquad ( 5 )$$

$$\overline{{Ψ}_{ι}^{t + 1}} = ( 1 - γ ) \overline{{Ψ}_{ι}^{t}} + {γΨ}_{i}^{t + 1} \qquad ( 6 )$$

### Updating Method 2

The experimental rule updating unit 114 calculates a statistical value (for example, a mean value) related to a change amount of an attribute value of each attribute by executing a statistical process using performance of a measure in an arbitrary period and sets the statistical value as a new cumulative change amount. The experimental rule updating unit 114 calculates a test indicator (for example, a p value) by executing a statistical process using performance of a measure in an arbitrary period and sets the test indicator as a new cumulative test indicator.

### Updating Method 3

The experimental rule updating unit 114 generates a distribution of appearance frequency of a change amount and a test indicator on the basis of the test record 123 and sets the change amount and the test indicator positioned on the 25 percentile as a new cumulative change amount and a new cumulative test indicator.

### Updating Method 4

The experimental rule updating unit 114 calculates a cumulative change amount by any of the updating methods 1 to 3. The experimental rule updating unit 114 updates a cumulative test indicator by Formula (7) using a correction factor ε. (1−g) expresses a decreasing rate.

$$\overline{{Ψ}_{ι}^{t + 1}} = ( 1 - g ) \overline{{Ψ}_{ι}^{t}} + g \frac{{ϵ}_{i}^{t + 1}}{\frac{1}{( t + 1 - τ )} {\sum }_{S = τ}^{t + 1} {ϵ}_{i}^{S}} {Ψ}_{i}^{t + 1} \qquad ( 7 )$$

The correction factor ε is given by Formula (8). σᵢ expresses a standard deviation of the change amount in an arbitrary period, and η expresses a mean value of the change amount in an arbitrary period. (σᵢ/η) expresses a variation coefficient.

$${ϵ}_{i} = max ( 0 , 1 - \frac{{σ}_{i}}{η} ) \qquad ( 8 )$$

The above-described updating methods are examples and the present invention is not limited to them. In the case of a measure implemented for the first time, a cumulative change amount and a cumulative test indicator do not exist. In this case, a change amount of an attribute value of an attribute is set as a cumulative change amount, and a test indicator is set as a cumulative test indicator.

The display unit 115 displays a screen indicating a cumulative change amount and a cumulative test indicator of each attribute in a measure on the basis of the measure management information 120.

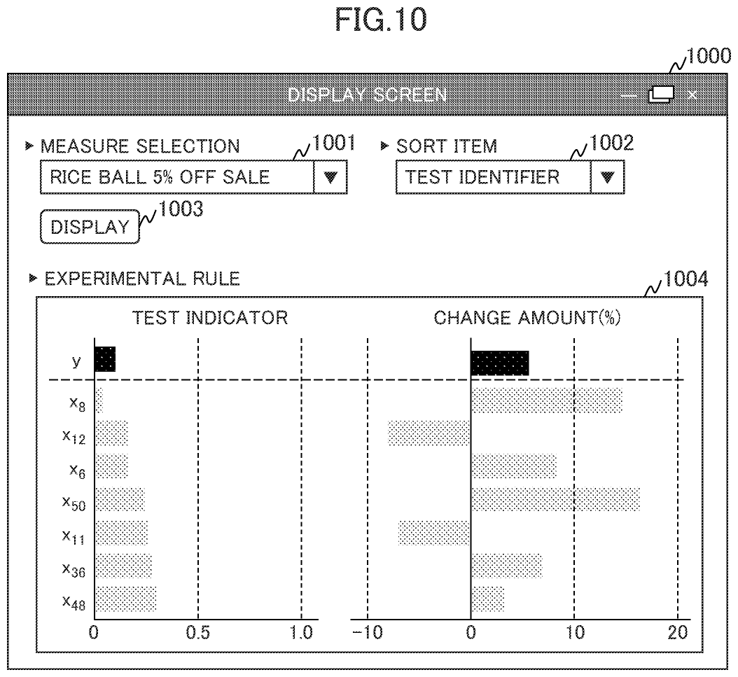

FIG. 10 is a diagram illustrating an example of a screen displayed by the display unit 115 of the first embodiment.

A screen 1000 includes a measure selection field 1001, a sort item selection field 1002, a display button 1003, and an experimental rule display field 1004.

The measure selection field 1001 is a field for selecting a measure. In the measure selection field 1001, contents of measures which can be selected are displayed as a pull-down menu. The sort item selection field 1002 is a field for selecting an item which determines a display order. In the sort item selection field 1002, “change amount” and “test indicator” are displayed as a pull-down menu.

The display button 1003 is a button for displaying a cumulative change amount and a cumulative test indicator of each of attributes in the measure selected in the measure selection field 1001. When the user operates the display button 1003, an experimental rule display request including identification information and items of the measure is output to the display unit 115.

When the experimental rule display request is received, the display unit 115 refers to the measure management information 120 and retrieves a record in which the identification information of the measure included in the request is set in the measure ID 301. The display unit 115 obtains the values of the cumulative change amount 304 and the cumulative test indicator 305 of the retrieved record. The display unit 115 sorts cumulative change amounts and cumulative test indicators of the attributes on the basis of the items included in the experimental rule display request and displays the sort result in the experimental rule display field 1004.

The experimental rule display field 1004 is a field for displaying a cumulative change amount and a cumulative test indicator of each of the attributes in the measure selected in the measure selection field 1001. In the experimental rule display field 1004, graphs indicating a cumulative change amount and a cumulative test indicator are displayed. In the graph displaying the cumulative change amount, the cumulative change amounts sorted according to the items selected in the sort item selection field 1002 are displayed. In the graph displaying the cumulative test indicator, the cumulative test indicators sorted according to the items selected in the sort item selection field 1002 are displayed.

In FIG. 10, the cumulative change amount and the cumulative test indicator of the attribute corresponding to the objective variable are displayed at the top regardless of the setting in the sort item selection field 1002.

Since the cumulative change amount and the cumulative test indicator of an attribute are values in which the performance of the measure is reflected, that is, values in which time change is reflected, they are useful as information for verifying the effect of the measure. The user can select an effective measure by referring to the cumulative change amount and the cumulative test indicator of an attribute. The user can perform re-examination, deletion, and the like of a measure whose effect is low.

By presenting information indicating the effect (change amount) and a significant different to all of the attributes for a measure, the user can verify the cause and effect among attributes. On the basis of the result of verification of the cause and effect, the user can also widen a target and a range to which a measure is provided.

### Second Embodiment

In a second embodiment, the computer 100 stores update records of a cumulative change amount and a cumulative test indicator of an attribute. Hereinafter, the second embodiment will be described mainly with respect to the difference from the first embodiment.

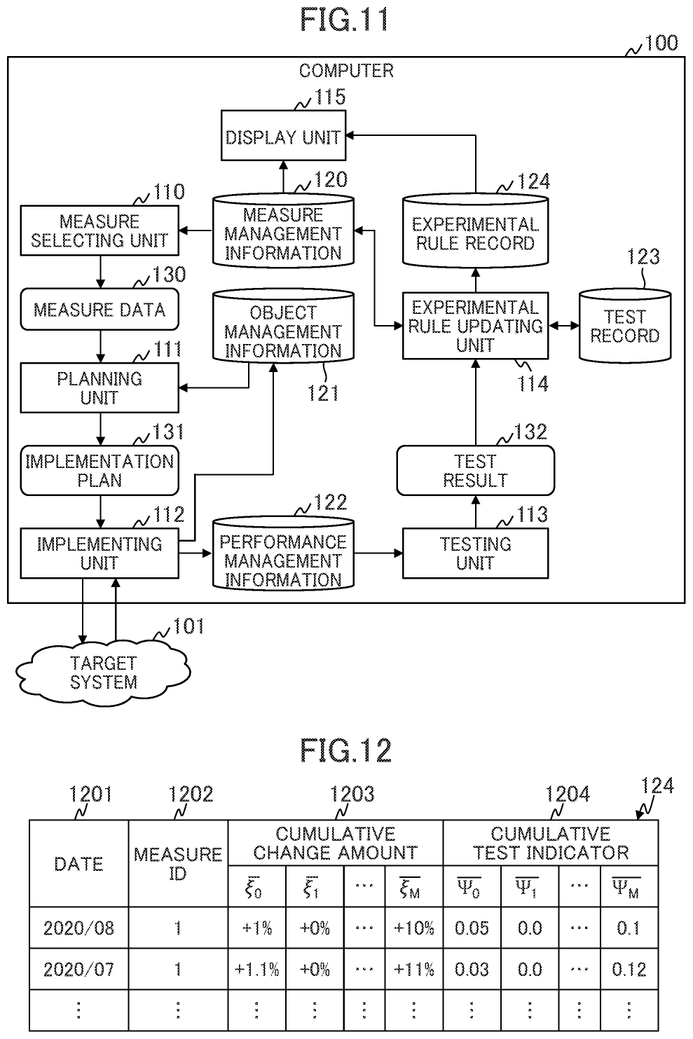

FIG. 11 is a diagram illustrating an example of the functional configuration of the computer 100 of the second embodiment.

The hardware configuration of the computer 100 of the second embodiment is the same as that of the first embodiment. The measure management information 120, the object management information 121, the performance management information 122, and the test record 123 of the second embodiment are the same as those of the first embodiment.

The sub storage device 203 of the computer 100 of the second embodiment stores an experimental rule record 124. FIG. 12 is a diagram illustrating an example of the experimental rule record 124 of the second embodiment.

The experimental rule record 124 stores a record including date 1201, measure ID 1202, a cumulative change amount 1203, and a cumulative test indicator 1204. For a combination of date and a measure, one record exists.

The date 1201 is a field for storing a measure implementation date. The measure ID 1202 is a field for storing identification information of a measure.

The cumulative change amount 1203 is a field group for storing a cumulative change amount calculated by the experimental rule updating unit 114. The cumulative test indicator 1204 is a field group for storing a cumulative test indicator calculated by the experimental rule updating unit 114.

Processes executed by the measure selecting unit 110, the planning unit 111, the implementing unit 112, and the testing unit 113 of the second embodiment are the same as those of the first embodiment.

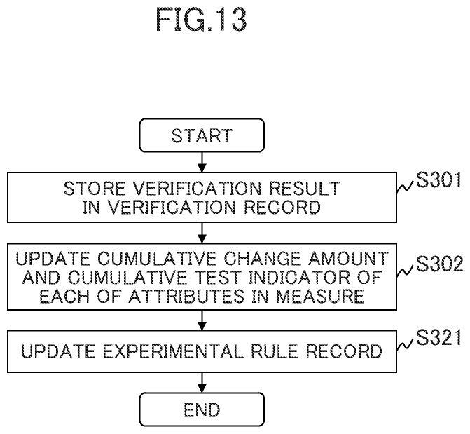

FIG. 13 is a flowchart explaining an example of processes executed by the experimental rule updating unit 114 of the second embodiment.

When the test result 132 is input from the testing unit 113, the experimental rule updating unit 114 starts processing.

The experimental rule updating unit 114 stores the test result 132 in the test record 123 (step S301).

The experimental rule updating unit 114 updates the cumulative change amount and the cumulative test indicator of each of the attributes in a measure to be tested (step S302).

The experimental rule updating unit 114 updates the experimental rule record 124 (step S321).

Concretely, the experimental rule updating unit 114 adds a record to the experimental rule record 124 and sets measure implementation date and identification information included in the test result 132 in the date 1201 and the measure ID 1202 of the added record. The experimental rule updating unit 114 sets the cumulative change amount and the cumulative test indicator calculated in step S302, in the cumulative change amount 1203 and the cumulative test indicator 1204 of the added record.

The display unit 115 of the second embodiment displays the screen 1000 indicating the cumulative change amount and the cumulative test indicator of each of the attributes in the measure on the basis of the measure management information 120. On the basis of the experimental rule record 124, the display unit 115 displays the screen indicating trend (time transition) of the cumulative change amount and the cumulative test indicator of each of the attributes in the measure.

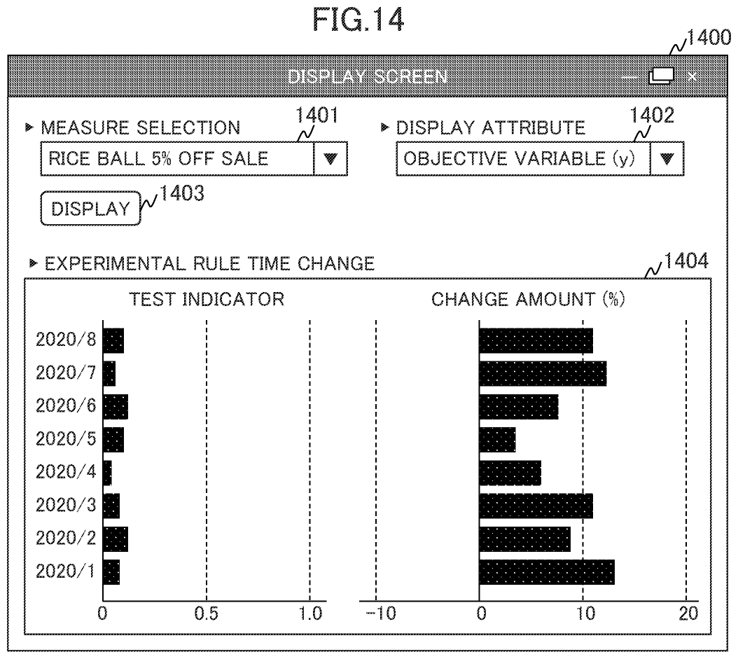

FIG. 14 is a diagram illustrating an example of the screen displayed by the display unit 115 of the second embodiment.

A screen 1400 includes a measure selection field 1401, a display attribute selection field 1402, a display button 1403, and a trend display field 1404.

The measure selection field 1401 is a field for selecting a measure. In the measure selection field 1401, contents of measures which can be selected are displayed as a pull-down menu. The display attribute selection field 1402 is a field of selecting an attribute displaying the trend of an indicator. In the display attribute selection field 1402, attributes which can be selected are displayed as a pull-down menu.

The display button 1403 is a button for displaying the trend of a cumulative change amount and a cumulative test indicator of the attribute selected in the display attribute selection field 1402, in the measure selected in the measure selection field 1401. In the case where the user operates the button, a trend display request including identification information of the measure and identification information of the attribute is output to the display unit 115.

When the trend display request is received, the display unit 115 refers to the experimental rule record 124 and retrieves a record in which the identification information of the measure included in the request is set in the measure ID 1202. The display unit 115 obtains the cumulative change amount and the cumulative test indicator of the attribute included in the trend display request from the cumulative change amount 1203 and the cumulative test indicator 1204 of the retrieved record. The display unit 115 displays the cumulative change amounts and cumulative test indicators in chronological order.

The trend display field 1404 is a field for displaying the trend of the cumulative change amount and the cumulative test indicator of each of the attributes in the measure. In the trend display field 1404, graphs indicating the trend of the cumulative change amount and the cumulative test indicator are displayed.

By presenting the trend of the cumulative test indicator and the like, the user can perform re-examination, deletion, and the like of a measure which does not have a significant different in the change amount of the attribute value.

### Third Embodiment

In a third embodiment, the computer 100 analyzes the periodicity of a cumulative change amount and a cumulative test indicator of an attribute. Hereinafter, the third embodiment will be described mainly with respect to the difference from the first and second embodiments.

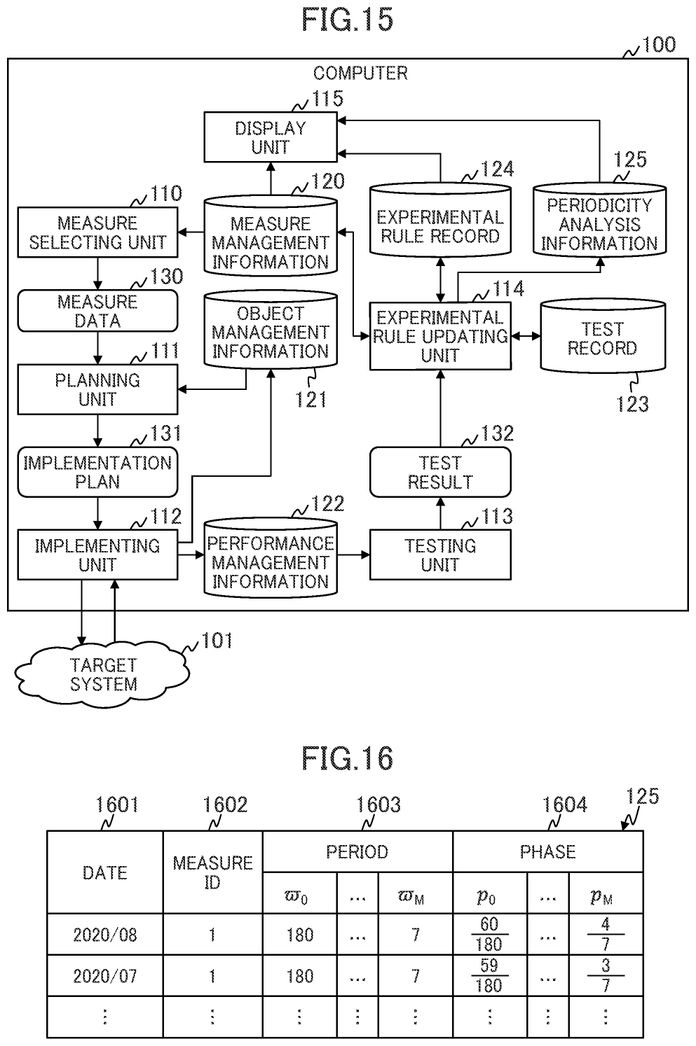

FIG. 15 is a diagram illustrating an example of the functional configuration of the computer 100 of the third embodiment.

The hardware configuration of the computer 100 of the third embodiment is the same as that of the first embodiment. The measure management information 120, the object management information 121, the performance management information 122, and the test record 123 of the third embodiment are the same as those of the first embodiment.

The sub storage device 203 of the computer 100 of the third embodiment stores the experimental rule record 124 and periodicity analysis information 125. The experimental rule record 124 of the third embodiment is the same as that of the second embodiment.

FIG. 16 is a diagram illustrating an example of the periodicity analysis information 125 of the third embodiment.

The periodicity analysis information 125 stores a record including date 1601, a measure ID 1602, a period 1603, and a phase 1604. For a combination of date and a measure, one record exists.

The date 1601 is a field storing measure implementation date. The measure ID 1602 is a field for storing identification information of a measure.

The period 1603 is a field for storing the period of a change of a cumulative change amount of an attribute. The phase 1604 is a field for storing the phase of a cumulative change amount of an attribute in the period.

The periodicity analysis information 125 may include the period of a change of a cumulative test indicator.

Processes executed by the measure selecting unit 110, the planning unit 111, the implementing unit 112, and the testing unit 113 of the third embodiment are the same as those of the first embodiment.

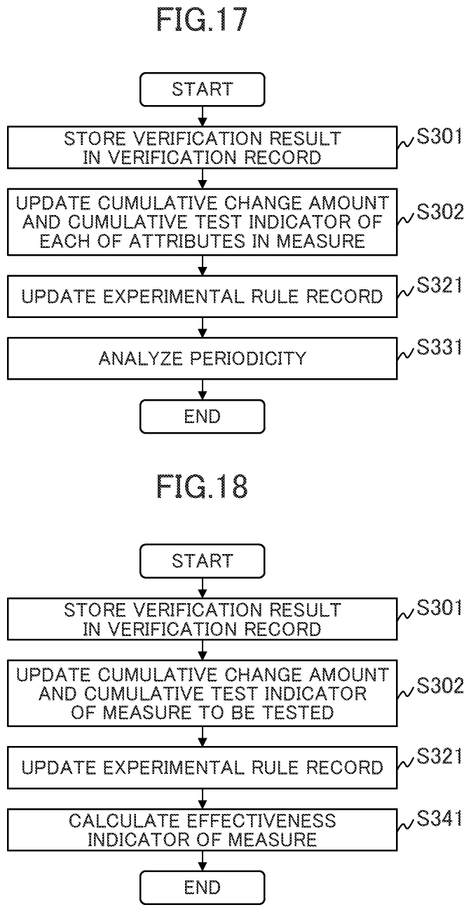

FIG. 17 is a flowchart explaining an example of processes executed by the experimental rule updating unit 114 of the third embodiment.

When the test result 132 is input from the testing unit 113, the experimental rule updating unit 114 starts processing.

The experimental rule updating unit 114 stores the test result 132 in the test record 123 (step S301).

The experimental rule updating unit 114 updates the cumulative change amount and the cumulative test indicator of each of the attributes in a measure to be tested (step S302).

The experimental rule updating unit 114 updates the experimental rule record 124 (step S321).

On the basis of the experimental rule record 124, the experimental rule updating unit 114 analyzes the periodicity of the cumulative change amount of each of the attributes in the measure to be texted (step S331). Concretely, the following processes are executed.

### (S331-1)

The experimental rule updating unit 114 adds a record in the periodicity analysis information 125. The experimental rule updating unit 114 sets the implementation date included in the test result 132 as the date 1601 of the record added, and sets the identification information included in the test result 132 as the measure ID 1620 of the added record.

### (S331-2)

The experimental rule updating unit 114 selects one of attributes which are set as variables of the evaluation model.

### (S331-3)

The experimental rule updating unit 114 retrieves a record including identification information of the measure selected in the measure ID 1202 from the experimental rule record 124.

### (S331-4)

The experimental rule updating unit 114 obtains the cumulative change amount of the selected attribute from the cumulative change amount 1203 of the retrieved record, and generates time-series data of the cumulative change amount of the selected attribute.

### (S331-5)

The experimental rule updating unit 114 calculates the period by executing spectral analysis for the time-series data of the cumulative change amount of the attribute. The experimental rule updating unit 114 sets the calculated period in the field corresponding to the attribute selected in the period 1603 of the added record in the periodicity analysis information 125.

### (S331-6)

The experimental rule updating unit 114 calculates the phase of the change amount included in the test result 132. The experimental rule updating unit 114 sets the calculated phase in the field corresponding to the selected attribute in the phase 1604 of the added record in the periodicity analysis information 125.

### (S331-7)

The experimental rule updating unit 114 determines whether the processes are completed or not on all of the attributes which are set as variables of the evaluation model. In the case where the processes have not been completed on all of the attributes, the experimental rule updating unit 114 returns to S331-2. In the case where the processes have been completed on all of the attributes, the experimental rule updating unit 114 finishes the process of step S331.

The process of step S331 has been described above.

The periodicity of the cumulative test indicator of each attribute may be also similarly analyzed.

The display unit 115 of the third embodiment displays the screen 1000 on the basis of the measure management information 120 and displays the screen 1400 on the basis of the experimental rule record 124. On the basis of the periodicity analysis information 125, the display unit 115 displays the screen indicating the periodicity of the change amount of the attribute value of each of the attributes of an arbitrary measure.

By presenting the periodicity of the change amount of the attribute value, the user can select a measure which is effective at present.

### Fourth Embodiment

In a fourth embodiment, the computer 100 calculates an indicator of effectiveness of a measure (effectiveness indicator). Hereinafter, the fourth embodiment will be described mainly with respect to the difference from the first and second embodiments.

The hardware configuration of the computer 100 of the fourth embodiment is the same as that of the first embodiment. The functional configuration of the computer 100 of the fourth embodiment is the same as that of the second embodiment.

The processes executed by the measure selecting unit 110, the planning unit 11, the implementing unit 112, and the testing unit 113 of the fourth embodiment are the same as those of the first embodiment.

FIG. 18 is a flowchart explaining an example of processes executed by the experimental rule updating unit 114 of the fourth embodiment.

When the test result 132 is input from the testing unit 113, the experimental rule updating unit 114 starts processing.

The experimental rule updating unit 114 stores the test result 132 in the test record 123 (step S301).

The experimental rule updating unit 114 updates the cumulative change amount and the cumulative test indicator of each of the attributes in a measure to be tested (step S302).

The experimental rule updating unit 114 updates the experimental rule record 124 (step S321).

The experimental rule updating unit 114 calculates the effective indicator of the measure (step S341). Concretely, the following processes are executed.

### (S341-1)

The experimental rule updating unit 114 refers to the object management information 121 and calculates the number of objects which match a measure application condition corresponding to the test result 132.

### (S341-2)

The experimental rule updating unit 114 refers to the measure management information 120 and obtains the value of the cumulative change amount 304 of the record of the measure corresponding to the test result 132. The experimental rule updating unit 114 calculates a computation value obtained by multiplying the cumulative change amount and the number of objects with respect to each of the attributes.

### (S341-3)

The experimental rule updating unit 114 outputs the computation value of each attribute as the effectiveness indicator of the measure to the display unit 115.

The process in step S341 has been described above.

The user can check the effectiveness of the implemented measure itself by referring to the effectiveness indicator.

The present invention is not limited to the foregoing embodiments but includes various modifications. For example, the forgoing embodiments have been described to make the present invention easily understood and the invention is not necessarily limited to the configurations having all of the components described. With respect to a part of the configuration of each embodiment, addition of another configuration, deletion, or replacement can be performed.

A part or all of the components, functions, processing units, processing means, and the like may be realized by hardware by, for example, designing by an integration circuit. The present invention can be realized also by a program code of software realizing the functions of the embodiments. In this case, a recording medium in which the program code is recorded is provided for a computer, and a processor of the computer reads the program code stored in the recording medium. In this case, the program code itself read from the recording medium realizes the functions of the embodiment, and the program code itself and the storage medium storing it are components of the present invention. As a storage medium for supplying such a program code, for example, a flexible disk, a CD-ROM, a DVD-ROM, a hard disk, an SSD (Solid State Drive), an optical disk, a magnetic optical disk, a CD-R, a magnetic tape, a non-volatile memory card, a ROM, or the like is used.

A program code realizing the functions described in the embodiments can be mounted by, for example, a program or a script language in a wide range such as assembler, C/C++, perl, Shell, PHP, Python, and Java (registered trademark).

Further, by distributing a program code of software realizing the functions of the embodiments via a network, it may be stored into storing means such as a hard disk or a memory of a computer or a storage medium such as a CD-RW or a CD-R, and a processor of the computer may read and execute the program code stored in the storing means or the storage medium.

In the foregoing embodiments, the control lines and information lines illustrated are considered to be necessary for the description, and all of control lines and information lines necessary for a product are not always illustrated. All of the components may be mutually connected.

What is claimed is:

1. A computer having a processor and a storage device connected to the processor, comprising:
a testing unit obtaining attribute values of a plurality of attributes from an object to which a measure is implemented and an object to which the measure is not implemented, calculating a change amount of the attribute values of the plurality of attributes due to the implementation of the measure, and calculating a test indicator for determining a significant difference of the change amount of the attribute values of the plurality of attributes due to the implementation of the measure;
an experimental rule updating unit accumulating a test result output from the testing unit, on the basis of the test result, calculating a cumulative change amount indicating a temporal change amount of the attribute values of the plurality of attributes due to the implementation of the measure and a cumulative test indicator indicating the temporal test indicator of the plurality of attributes due to the implementation of the measure, and accumulating data in which the identification information of the measure and the cumulative change amount and the cumulative test indicator of the plurality of attributes are associated; and
a display unit displaying the cumulative change amount and the cumulative test indicator associated with a designated measure on the basis of the data.

2. The computer according to claim 1, wherein the testing unit generates the test result including identification information of the measure and the change amount and the test indicator of the attribute values of the plurality of attributes, and
the experimental rule updating unit
obtains the test result,
obtains the cumulative change amount and the cumulative test indicator of the plurality of attributes from the data corresponding to the identification information of the measure included in the test result,
calculates a new cumulative change amount of the plurality of attributes on the basis of the change amount of the attribute values of the plurality of attributes and the cumulative change amount of the plurality of attributes included in the test result,
calculates a new cumulative test indicator of the plurality of attributes on the basis of the test indicator of the plurality of attributes and the cumulative test indicator of the plurality of attributes included in the test result, and
makes the new cumulative change amount and the new cumulative test indicator of the plurality of attributes reflected in the data.

3. The computer according to claim 2, wherein the experimental rule updating unit accumulates an experimental rule record in which identification information of the measure included in the test result and the new cumulative change amount and the new cumulative test indicator are associated, and
the display unit displays information indicating time transition of the cumulative change amount and the cumulative test indicator of an arbitrary attribute in a designated measure on the basis of the experimental rule record.

4. The computer according to claim 3, wherein the experimental rule updating unit analyzes periodicity of changes in the attribute values of the plurality of attributes accompanying implementation of the measure on the basis of the experimental rule record, and
the display unit displays an analysis result of the periodicity.

5. The computer according to claim 1, wherein the data includes identification information of the measure, information of an application condition for selecting an object to which the measure is applied, and the cumulative change amount and the cumulative test indicator of the plurality of attributes,
the computer holds object management information which manages the attribute values of the plurality of attributes of a plurality of objects,
the testing unit updates the object management information on the basis of the attribute values of the plurality of attributes,
the experimental rule updating unit refers to the object management information on the basis of the data corresponding to the identification information of the measure included in the test result and calculates the number of objects matching the application condition of the measure, and calculates a value obtained by multiplying the cumulative change amount of the plurality of attributes and the number of objects as an effectiveness indicator, and
the display unit displays the effectiveness indicator.

6. A method of evaluating a measure implemented on an object executed by a computer, the computer including a processor and a storage device connected to the processor, the method comprising:
a first step, by the processor, of obtaining attribute values of a plurality of attributes from an object to which a measure is implemented and an object to which the measure is not implemented, and calculating a change amount of the attribute values of the plurality of attributes due to the implementation of the measure and a test indicator for determining a significant difference of a change amount of the attribute values of the plurality of attributes due to the implementation of the measure;
a second step, by the processor, of generating a test result including identification information of the measure, the change amount of the attribute values of the plurality of attributes, and the test indicator and storing the test result in the storage device;
a third step, by the processor, of calculating a cumulative change amount indicating a temporal change amount of the attribute values of the plurality of attributes due to the implementation of the measure and a cumulative test indicator indicating the temporal test indicator of the plurality of attributes due to the implementation of the measure on the basis of the test result;
a fourth step, by the processor, of storing data in which the identification information of the measure and the cumulative change amount and the cumulative test indicator of the plurality of attributes are associated into the storage device; and
a fifth step, by the processor, of displaying the cumulative change amount and the cumulative test indicator associated with a designated measure on the basis of the data.

7. The measure evaluating method according to claim 6, wherein the third step includes:
a step of obtaining the cumulative change amount and the cumulative test indicator of the plurality of attributes from the data corresponding to the identification information of the measure included in the test result by the processor;
a step of calculating a new cumulative change amount of the plurality of attributes on the basis of the change amount of the attribute values of the plurality of attributes and the cumulative change amount of the plurality of attributes included in the test result by the processor, and
a step of calculating a new cumulative test indicator of the plurality of attributes on the basis of the test indicator of the plurality of attributes and the cumulative test indicator of the plurality of attributes included in the test result by the processor, and
the fourth step includes a step of making the new cumulative change amount and the new cumulative test indicator of the plurality of attributes reflected in the data by the processor.

8. The measure evaluating method according to claim 7, wherein the third step includes a step of storing an experimental rule record in which identification information of the measure included in the test result and the new cumulative change amount and the new cumulative test indicator are associated into the storage device by the processor, and
the fifth step includes a step of displaying information indicating time transition of the cumulative change amount and the cumulative test indicator of an arbitrary attribute in a designated measure on the basis of the experimental rule record by the processor.

9. The measure evaluating method according to claim 8, further comprising a step of analyzing periodicity of changes of the attribute values of the plurality of attributes accompanying implementation of the measure on the basis of the experimental rule record by the processor,
wherein the fifth step includes a step of displaying a result of analyzing the periodicity by the processor.

10. The measure evaluating method according to claim 6, wherein the data includes identification information of the measure, information of an application condition for selecting an object to which the measure is applied, and the cumulative change amount and the cumulative test indicator of the plurality of attributes,
the storage device stores object management information which manages the attribute values of the plurality of attributes of a plurality of objects, and
the first step includes a step of updating the object management information on the basis of the attribute values of the obtained plurality of attributes by the processor,
the measure evaluating method further comprising:
a step of referring to the object management information on the basis of the data corresponding to the identification information of the measure included in the test result and calculating the number of objects matching the application condition of the measure by the processor; and
a step of calculating a value obtained by multiplying the cumulative change amount of the plurality of attributes and the number of objects as an effectiveness indicator by the processor,
wherein the fifth step includes a step of displaying the effectiveness indicator by the processor.
